(19) United States
(12) Patent Application Publication
(10) Pub. No.: US 2026/0155678 A1
(43) Pub. Date: Jun. 4, 2026

(54) CURRENT MODULATED ASYNCHRONOUS SERIAL COMMUNICATION

(71) Applicant: Zebra Technologies Corporation, Lincolnshire, IL (US)

(72) Inventors: Mathew G. Locoteta, Shoreham, NY (US); Carl Irekvist, Oakville (CA); Damien Ramrattan, Coram, NY (US)

(21) Appl. No.: 18/964,441

(22) Filed: Nov. 30, 2024

(51) Int. Cl. H02J 50/00; H02J 7/00; H02J 50/10

(52) U.S. Cl. CPC H02J 50/005; H02J 7/731; H02J 50/10

(57) ABSTRACT

Techniques are proposed for establishing data communications between a wireless charging cradle and a handheld barcode scanner in the absence of a mechanical charging/data contact point. A handled barcode scanner modulates its power draw to communicate data to the wireless charging cradle (e.g., using an inverted asynchronous serial communication protocol). The wireless charging cradle uses a current sense amplifier to identify and interpret high and low voltages proportional to the power draw to interpret the data communicated by the handheld barcode scanner. The wireless charging cradle thereby receives communications from the handheld barcode scanner, e.g., to facilitate establishment of a wireless radiofrequency (RF) link with the handheld barcode scanner.

### FIELD OF THE DISCLOSURE

The present disclosure relates to wireless power transfer systems, and more particularly, to establishing wireless data communications between a handheld barcode scanner and a wireless charging cradle.

### BACKGROUND

Wireless power transfer systems are capable of transmitting electrical energy from a transmitter to a receiver without using a physical link. For example, in existing near field wireless power transfer systems, a wireless power transmitter forms an inductive coupling with a receiver when the receiver is placed on or near an inductive charging pad or other wireless charging contact point of the wireless power transmitter. These systems are often used, for example, to charge batteries of smartphones, tablets, RFID devices, medical devices, etc.

In another endeavor, barcode imaging devices, such as handheld barcode scanners, are capable of capturing images of indicia (e.g., barcodes, QR codes, etc.) to identify an item, person, task, entity, etc. associated with the indicia. A handheld barcode scanners may, for example, be carried by a person and used to scan and track products in an inventory management system. The handheld barcode scanner typically includes an internal battery that receives charge from a charging cradle, so as to allow the person to carry and use the handheld barcode scanner for a duration of time after disconnecting the handheld barcode scanner from the charging cradle. Typically, the charging of the handheld barcode scanner relies on a wired connection or other mechanical contact between the handheld barcode scanner or charging cradle while the handheld barcode scanner is placed in the charging cradle. This mechanical contact can also be used to establish data communications between the handheld barcode scanner and the charging cradle, if and when so desired (e.g., to provide wired data transfer, and/or to establish communications to subsequently occur via a wireless data communication protocol).

### SUMMARY

In some embodiments, a wireless charging cradle is provided, the wireless charging cradle being configured to receive a handheld barcode scanner. The wireless charging cradle may include a current sense amplifier configured to (i) measure a current drawn by the handheld barcode scanner via a wireless electrical coupling of the wireless charging cradle to the handheld barcode scanner, and (ii) convert the measured current to an output voltage. The wireless charging cradle also includes a holster configured to physically receive the handheld barcode scanner. The wireless charging cradle further includes one or more processors and one or more non-transitory memories storing instructions. The instructions, when executed by the one or more processors, may cause the wireless charging cradle to (1) detect a placement of the handheld barcode scanner in the holster, and (2) responsive to detecting the placement of the handheld barcode scanner, (i) identify a first output voltage of the current sense amplifier as corresponding to a low current signal from the handheld barcode scanner, (ii) identify a second output voltage of the current sense amplifier as corresponding to a high current signal from the handheld barcode scanner, and (iii) perform further electrical signal communications with the handheld barcode scanner via the wireless electrical coupling to establish a wireless data link between the wireless charging cradle and the handheld barcode scanner, wherein performing the further electrical signal communications comprises reading further electrical current signals from the handheld barcode scanner based on the identifying of the first output voltage and second output voltage.

In some embodiments, a computer-implemented method is performed via one or more processors of a wireless charging cradle configured to receive a handheld barcode scanner. The method may include (1) detecting a placement of the handheld barcode scanner in a holster of the wireless charging cradle, and (2) responsive to detecting the placement of the handheld barcode scanner, (i) identifying a first output voltage of a current sense amplifier of the wireless charging cradle as corresponding to a low current signal received over a wireless electrical coupling from the handheld barcode scanner, (ii) identifying a second output voltage of the current sense amplifier as corresponding to a high current signal received over the wireless electrical coupling from the handheld barcode scanner, and (iii) performing further electrical signal communications with the handheld barcode scanner via the wireless electrical coupling to establish a wireless data link between the wireless charging cradle and the handheld barcode scanner, wherein performing the further electrical signal communications comprises reading further electrical current signals from the handheld barcode scanner based on the identifying of the first output voltage and second output voltage.

In some embodiments, one or more non-transitory computer readable media store instructions executable via one or more processors of a wireless charging cradle configured to receive a handheld barcode scanner. The instructions, when executed, may cause the wireless charging cradle to (1) detect a placement of the handheld barcode scanner in a holster of the wireless charging cradle, and (2) responsive to detecting the placement of the handheld barcode scanner, (i) identify a first output voltage of a current sense amplifier of the wireless charging cradle as corresponding to a low current signal received over a wireless electrical coupling from the handheld barcode scanner, (ii) identify a second output voltage of the current sense amplifier as corresponding to a high current signal received over the wireless electrical coupling from the handheld barcode scanner, and (iii) perform further electrical signal communications with the handheld barcode scanner via the wireless electrical coupling to establish a wireless data link between the wireless charging cradle and the handheld barcode scanner, wherein performing the further electrical signal communications comprises reading further electrical current signals from the handheld barcode scanner based on the identifying of the first output voltage and second output voltage.

In some embodiments, identifying the first output voltage includes (1) monitoring the output voltage of the current sense amplifier over a monitoring window to identify a baseline output voltage of the current sense amplifier, and (2) identify the baseline output voltage as being the first output voltage corresponding to a low current signal from the handheld barcode scanner. Moreover, in some embodiments, identifying the second output voltage includes (1) further monitoring the output voltage of the current sense amplifier over the monitoring window to identify a deviation from the baseline output voltage of the current sense amplifier, the deviation producing a spike output voltage, and (2) identify the spike output voltage as being the second output voltage corresponding to a high current signal from the handheld barcode scanner.

In some embodiments, identifying the first and second output voltages includes monitoring the output voltage of the current sense amplifier over a monitoring window to (1) identifying the first output voltage based on the first output voltage being below a predefined threshold voltage, and (2) identifying the second output voltage based on the second output voltage being above the threshold voltage.

In some embodiments, the wireless charging cradle measures output voltage of the current sense amplifier by averaging the output voltage over an averaging window. Moreover, in some embodiments, the further electrical signal communications utilize an inverted asynchronous serial communication protocol.

In some embodiments, the wireless data link utilizes a Bluetooth communication protocol (or alternatively Wi-Fi and/or other radiofrequency (RF) communications).

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example handheld barcode scanner and wireless charging cradle, in accordance with various embodiments described herein.

FIG. 2 depicts another example system including a handheld barcode scanner and wireless charging cradle, in accordance with various embodiments described herein.

FIG. 3 depicts a block diagram of an example computer-implemented method for establishing a wireless data link, in accordance with various embodiments described herein.

FIG. 4 depicts example waveforms in an inverted asynchronous serial communication protocol, in accordance with various embodiments described herein.

FIG. 5 depicts a block diagram of an example computer-implemented method for identifying high and low voltages corresponding to current signals from a handheld barcode scanner, in accordance with various embodiments described herein.

FIG. 6 depicts a block diagram of another example computer-implemented method for identifying the high and low voltages, in accordance with various embodiments described herein.

FIG. 7 depicts a block diagram of still another example computer-implemented method, in accordance with various embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Systems and methods of present disclosure involve power transfer and exchange of data communications between a handheld barcode scanner and a wireless charging cradle.

More particularly, the present disclosure identifies a desire to replace the traditional, mechanical charging mechanism for a handheld barcode scanner with a wireless charging mechanism, e.g., using Qi and/or another wireless power transfer protocol(s) for inductive power transfer from the charging cradle to the handheld barcode scanner when the handheld barcode scanner is holstered in the charging cradle. The present disclosure also identifies, though, that when the traditional wired charging mechanism is substituted for a wireless charging solution, the removal of the mechanical charging contact point also impedes data communications between the handheld barcode scanner and the charging cradle, as systems have traditionally used this contact point both to charge and to establish data communications between the handheld barcode scanner and the charging cradle.

In view of these challenges, the present disclosure proposes techniques for establishing a wireless data link between a wireless charging cradle and a handheld barcode scanner in the absence of a mechanical charging/data contact point, via causing and detecting modulations in wireless current signals exchanged between the wireless charging cradle and the handheld barcode scanner. At a high level, the handheld barcode scanner modulates a load (or “power draw”) thereof to cause the wireless charging cradle to wirelessly provide varying amounts of electrical current to the handheld barcode scanner via a wireless electrical coupling. A current sense amplifier and analog-to-digital converter (ADC) of the wireless charging cradle measures the provided current, and the wireless charging cradle identifies “high” and “low” measured current or voltages as corresponding to high (1) and low (0) binary values from the handheld barcode scanner.

Multiple alternative techniques are proposed herein for the wireless charging cradle identifying the high and low voltages. In any case, though, by the wireless charging cradle measuring and interpreting the modulations in power draw from the handheld barcode scanner, the handheld barcode scanner is enabled to communicate data to the wireless charging cradle over the wireless electrical coupling by modulating its own power draw. The wireless charging cradle and handheld barcode scanner may use these communications to establish a communicative pairing therebetween, to be used to exchange further communications between the wireless charging cradle and the handheld barcode scanner (e.g., Wi-Fi pairing, Bluetooth pairing, another proprietary radiofrequency (RF) pairing, and/or continued power-based data communications).

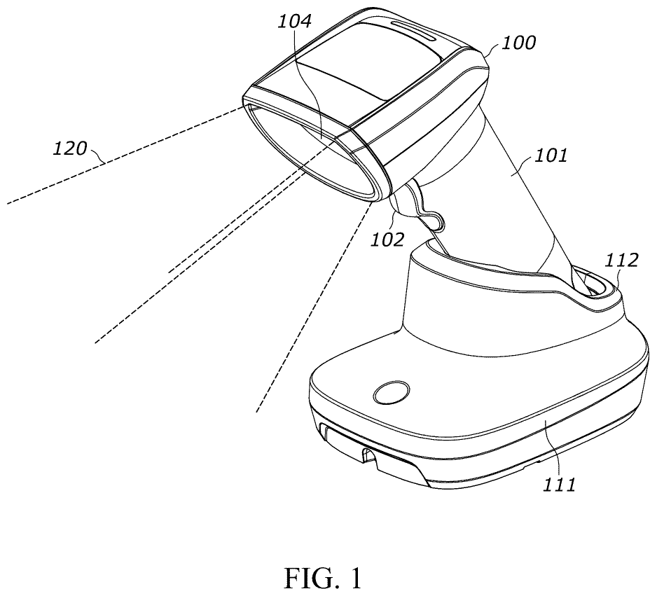

FIG. 1 depicts an example arrangement of a system that may implement techniques of this disclosure, in accordance with various embodiments described herein. As shown in FIG. 1, a handheld barcode scanner 100 includes a housing having a handle or a lower housing portion 101, a trigger 102, and an optical imaging assembly 104 that includes one or more image sensors and/or one or more illumination sources. The optical imaging assembly 104 is at least partially positioned within the housing and has a field of view (FOV) 120, and the optical imaging assembly 104 includes an optically transmissive window and/or lens(es). Activation of the handheld barcode scanner 100 (e.g., using the trigger 102) enables the handheld barcode scanner 100 to detect and/or interpret indicia (e.g., barcodes, QR codes, etc.) appearing in the FOV 120.

The system of FIG. 1 further includes a cradle 111 configured to physically receive the handheld barcode scanner 100, for example for presentation and/or to wirelessly charge a battery of the handheld barcode scanner 100 via a power supply of the cradle 111. Accordingly, the cradle 111 will be referred to herein as a “wireless charging cradle.” In the arrangement of FIG. 1, the wireless charging cradle 111 may receive the handheld barcode scanner 100 via the lower housing portion 101 being physically placed in a dock portion 112 of the wireless charging cradle 111.

To provide wireless charging in this arrangement, each of the wireless charging cradle 111 and handheld barcode scanner 100 may for example include respective inductive coils positioned such that the induction coils are within a suitable range to form an inductive coupling and transfer electrical current therebetween. In one particular example, the handheld barcode scanner 100 includes an induction coil on a bottom surface of the lower housing portion 101, and the wireless charging cradle includes another induction coil on a top surface of the dock portion 112, so as to place the induction coils in physical proximity when the wireless charging cradle 111 receives the handheld barcode scanner 100.

It should be appreciated that the forms, shapes, and physical arrangements of the wireless charging cradle 111 and handheld barcode scanner 100 in FIG. 1 are provided by way of example only. That is, various other arrangements are possible, in various embodiments. For example, in another embodiment, the wireless charging cradle 111 may physically receive the handheld barcode scanner 100 by docking an optical imaging assembly 104, e.g., so as to place an induction coil on or in the optical imaging assembly 104 in physical proximity to an induction coil of the wireless charging cradle 111.

In any case, as will be described further herein, the wireless charging cradle 111 may be configured to detect when the handheld barcode scanner 100 is physically received by the wireless charging cradle 111. The wireless charging cradle may, for example, detect the wireless power draw from the handheld barcode scanner 100, and recognize from the power draw that the induction coils of the respective devices are in physical proximity and thus the handheld barcode scanner 100 is docked in the wireless charging cradle 111.

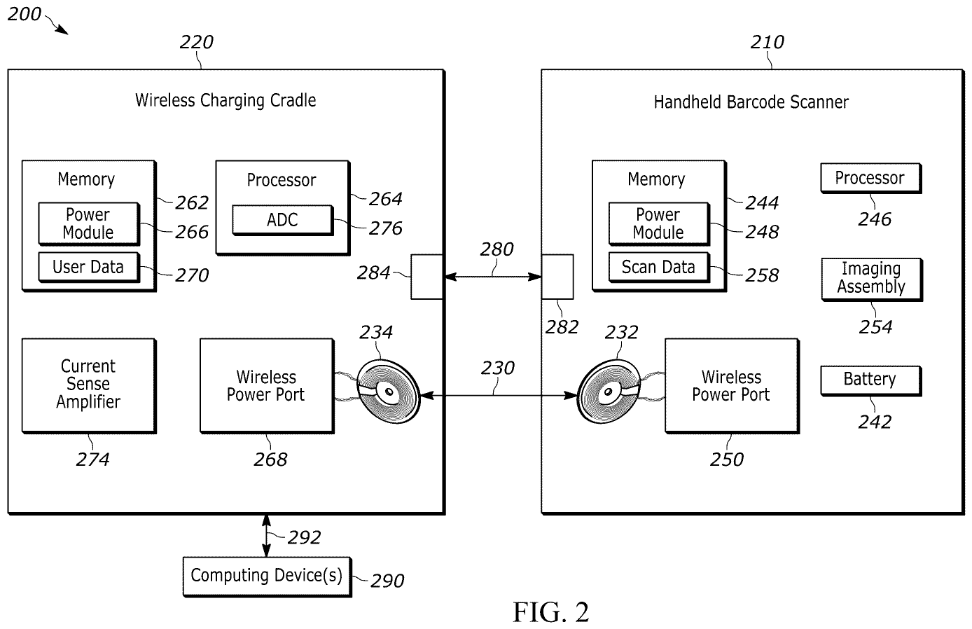

FIG. 2 depicts a block diagram of another example system 200, in accordance with various embodiments herein. The system 200 includes a handheld barcode scanner 210 and a wireless charging cradle 220, which may for example correspond to the handheld barcode scanner 100 and wireless charging cradle 111 of FIG. 1, respectively.

The handheld barcode scanner 210 and wireless charging cradle 220 are electrically coupled by a wireless electrical coupling 230 when the wireless charging cradle 220 physically receives the handheld barcode scanner 210 (e.g., when the handheld barcode scanner 210 is placed in a holster of the wireless charging cradle 220, for example in an arrangement described with respect to FIG. 1). The wireless electrical coupling 230 may, for example, be an inductive coupling between induction coils 232 and 234 of the handheld barcode scanner 210 and wireless charging cradle 220, respectively (e.g., using the Qi protocol and/or another wireless charging protocol). Generally speaking, when the handheld barcode scanner 210 and wireless charging cradle 220 are electrically coupled, the handheld barcode scanner 210 acts as a load on the wireless charging cradle 220, drawing power from the wireless charging cradle 220 to charge a rechargeable battery 242 of the handheld barcode scanner 210.

The handheld barcode scanner 210 includes a memory 244 (i.e., one or more memories, e.g., non-transitory memory) storing instructions executable by a processor 246 (i.e., one or more processors). In particular, non-transitory portions of the memory 244 may include a power module 248, which may set and dynamically adjust the power draw by the handheld barcode scanner 210 via a wireless power port 250 (i.e., one or more transmit (Rx) and, in some embodiments, one or more transmit (Tx) ports).

The handheld barcode scanner 210 further includes an imaging assembly 254 configured to enable the handheld barcode scanner 210 to detect indicia such as barcodes, QR codes, etc. in an environment (e.g., the optical imaging assembly 104 of FIG. 1). The imaging assembly 254 may include one or more image sensors, which may for example include a plurality of photosensitive elements arranged on a substantially flat plane (e.g., forming a grid or series of arrays on the plane). The imaging assembly 254 may further include an illumination source (i.e., one or more illumination sources) and associated optics to provide radiation to a field of view (FOV) of the handheld barcode scanner 210). In some embodiments, the imaging assembly 254 attempts to detect indicia only in response to one or more stimuli (e.g., activation of the trigger 102 as described with respect to FIG. 1). Alternatively, in other embodiments, the imaging assembly 254 is continuously active to attempt to detect indica as long as the handheld barcode scanner 210 is powered.

Additionally to the power module 248, non-transitory portions of the memory 244 may include scan data 258, indicating indicia previously detected by the handheld barcode scanner 210. For example, in embodiments, the handheld barcode scanner 210 stores the scan data 258 locally at the memory 244 until the handheld barcode scanner is communicatively connected to one or more other devices onto which the handheld barcode scanner 210 can offload the scan data 258 to the one or more other devices (e.g., the wireless charging cradle 220 and/or another device(s)).

Still referring to FIG. 2, the wireless charging cradle 220 includes a memory 262 (i.e., one or more memories, e.g., one or more non-transitory memories) storing instructions executable by a processor 264 (i.e., one or more processors). In particular, non-transitory portions of the memory 262 may include a power module 266 configured to control provision of power to the handheld barcode scanner 210 via a wireless power port 268 (i.e., at least one or more Tx ports and, in some embodiments, one or more Rx ports). Non-transitory portions of the memory 262 may also store user data 270, which may for example include records of indicia scanned by the handheld barcode scanner 210 (e.g., from the scan data 258), records of power draw and/or communications from the handheld barcode scanner 210, and/or various other data described herein.

The wireless charging cradle 220 further includes a current sense amplifier 274, which detects and measures current flowing out of the wireless charging cradle 220 to charge the handheld barcode scanner 210. Specifically, based on a current flowing into the current sense amplifier 274 toward the electrical coupling 230, the current sense amplifier 274 produces an analog output voltage proportional to the current. An analog-to-digital converter (ADC) 276 on the processor 264 converts the analog output voltage to a digital representation thereof (“digital voltage”). The current flowing into the current sense amplifier corresponds to the instantaneous power draw by the handheld barcode scanner. Thus, modulations to the power draw of the handheld barcode scanner 210 are reflected proportionally by the digital voltage produced by the ADC 276. At a very high level, techniques of the present disclosure include the wireless charging cradle 220 identifying high and low output digital voltage values as corresponding to high and low “current signals” from the handheld barcode scanner 210 representing binary communications.

Still referring to FIG. 2, the system 200 in some embodiments includes still another one or more computing devices 290 in communication with the wireless charging cradle 220 via one or more communication links 292 (e.g., a wired communication link, and/or a wireless communication link such as Wi-Fi, Bluetooth, etc.). The one or more computing devices 290 may, for example, include a workstation or another device configured to receive the user data 270, e.g., to allow a user of the one or more computing devices 290 to review, analyze, and/or process information indicative of indicia scanned by the handheld barcode scanner 210. The one or more computing devices 290 may, as another example, include a power source of the wireless charging cradle 220, to which the wireless charging cradle 220 may be connected wirelessly or via a wired connection (i.e., the “wireless” aspect of the charging cradle 220 refers to its capability to charge and communicate with the handheld barcode scanner 210 without a wired connection).

The system 200 may include still additional, fewer, and/or alternate components, in various embodiments.

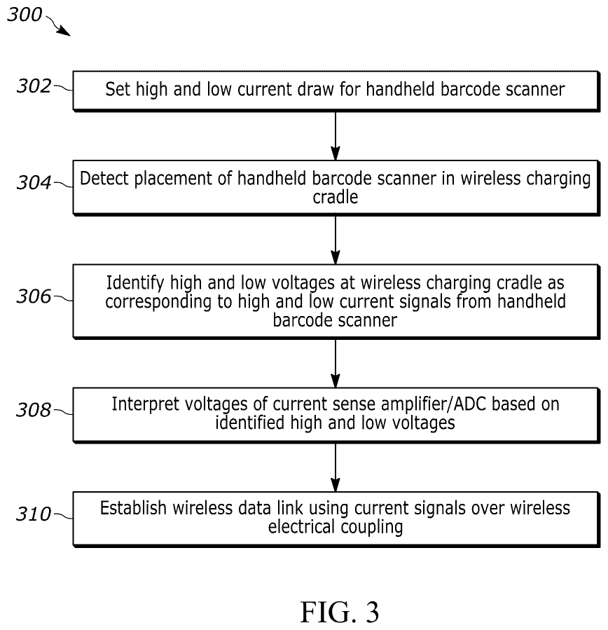

According to techniques of the present disclosure, the handheld barcode scanner 210 communicates data to the wireless charging cradle 220 in the absence of a mechanical communication link by the handheld barcode scanner 210 modulating its power draw between “high” and “low” values representing binary values of 1 and 0, and by the wireless charging cradle 220 detecting and interpreting these modulations as the binary values indicating data. These techniques will be described with respect to block diagrams of computer-implemented methods depicted in FIG. 3 and FIGS. 5-7.

Although these methods will be described with reference to components of the system 200 of FIG. 2, it should be appreciated that some or all actions of the methods of FIGS. 3, 5, 6, and/or 7 may be another suitable computing system, in various possible embodiments. Moreover, it should be appreciated that actions of the methods of FIGS. 3, 5, 6, and/or 7 may be combined with each other, in various embodiments.

Generally speaking, actions of the methods of FIGS. 3, 5, 6, and/or 7 may be performed by the handheld barcode scanner 210, wireless charging cradle 220, or some combination thereof. In embodiments, the methods of FIGS. 3, 5, 6, and/or 7 are performed via one or more processors (e.g., processor 246 and/or 264) executing instructions stored on ne or more non-transitory memories (e.g., memory 244 and/or 262, or more particularly the power module 248 and/or 266). In some embodiments, one or more non-transitory computer readable media store instructions that, when executed via one or more processors, cause one or more computing devices to perform actions of the methods of FIGS. 3, 5, 6, and/or 7 (e.g., the processor 246 causing actions of the handheld barcode scanner 210, and/or the processor 264 causing actions of the wireless charging cradle 220).

Beginning with FIG. 3, with reference back to FIG. 2, a computer-implemented 300 is provided for establishing a wireless data link between the handheld barcode scanner 210 and the wireless charging cradle 220 via communications over the wireless electrical coupling 230. The method 300 may be performed via a combination of actions by the handheld barcode scanner 210 and the wireless charging cradle 220.

The method 300, at action 302, includes setting high and low current draw values (power draw) at the handheld barcode scanner 210. The high and low current draw values (and instructions for modulation therebetween) may, for example, be stored at the power module 248 of memory 244 at the handheld barcode scanner 210.

At action 304, the method 300 includes detecting a placement of the handheld barcode scanner 210 in a holster of the wireless charging cradle 220. The wireless charging cradle 220 may detect this event, for example, by detecting a first power draw from the handheld barcode scanner 210 (that is, the handheld barcode scanner 210 does not draw power from the wireless charging cradle 220 when the handheld barcode scanner 210 is not holstered). The handheld barcode scanner 210 may likewise detect the placement in the wireless charging cradle 220 when the handheld barcode scanner detects receipt of power over the wireless electrical coupling 230.

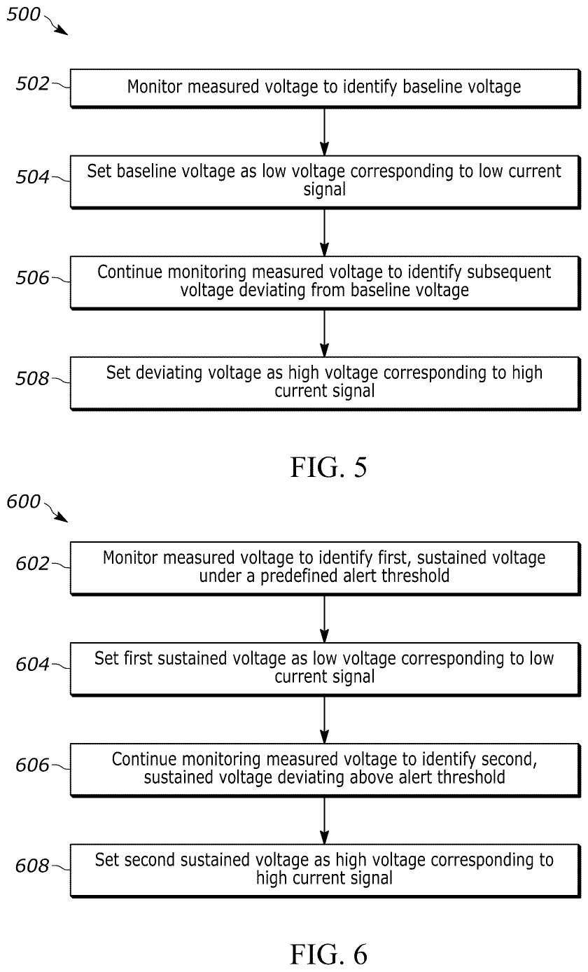

When the handheld barcode scanner 210 is holstered, the handheld barcode scanner 210 modulates its own power draw to communicate data to the wireless charging cradle 220. At action 306 of the method 300, the wireless charging cradle 220 identifies comparatively higher and lower current draws by the handheld barcode scanner 210 by identifying “high” and “low” digital voltages via the current sense amplifier 274 and ADC 276. Multiple alternative techniques are proposed herein for identifying the high and low voltage values, as will described in further detail with respect to methods of FIGS. 5 and 6. In any case, though, the wireless charging cradle 220 identifies the high and low voltages as corresponding to high and low power draws indicating data from the handheld barcode scanner 210 (“high and low current signals”).

At action 308, the wireless charging cradle 220 interprets voltages measured via the current sense amplifier 274 and/or ADC 276 based on the identified high and low voltages. The high and low voltages may correspond to binary values of one and zero, respectively (or vice versa). By identifying and interpreting the variations between the high and low voltages, the wireless charging cradle 220 in effect receives data communications from the handheld barcode scanner 210 in the absence of a mechanical communication or any other established communication link therebetween.

Basis on actions 306 and 308, the method 300 still further includes, at action 310, establishing the wireless data link 280 between the wireless charging cradle 220 and handheld barcode scanner 210 using current signals over the wireless electrical coupling 230 (e.g., using the aforementioned current signals and subsequent current signals to communicate further data). Action 310 may for example include establishing a Wi-Fi link, Bluetooth link, and/or another RF communication link.

An example communication protocol for establishing the wireless data link 280 may include using current signals to transmit a START bit, eight DATA bits, and a STOP bit by the handheld barcode scanner 210. The current signal transmissions may occur at a predefined baud rate (e.g., defined at the memory 244). In some embodiments, the protocol may further include a PARITY bit from the handheld barcode scanner 210 for error correction. In some embodiments, the protocol at action 310 may be an inverted asynchronous serial communication protocol wherein, rather than the handheld barcode scanner 210 modulating from a substantial default power draw, the handheld barcode scanner 210 at rest does not draw power (default of substantially zero power draw, e.g., indicating a 0 bit). Using the inverted protocol, power consumption by the handheld barcode scanner 210 is decreased while the handheld barcode scanner 210 is not transmitting data to the wireless charging cradle 220.

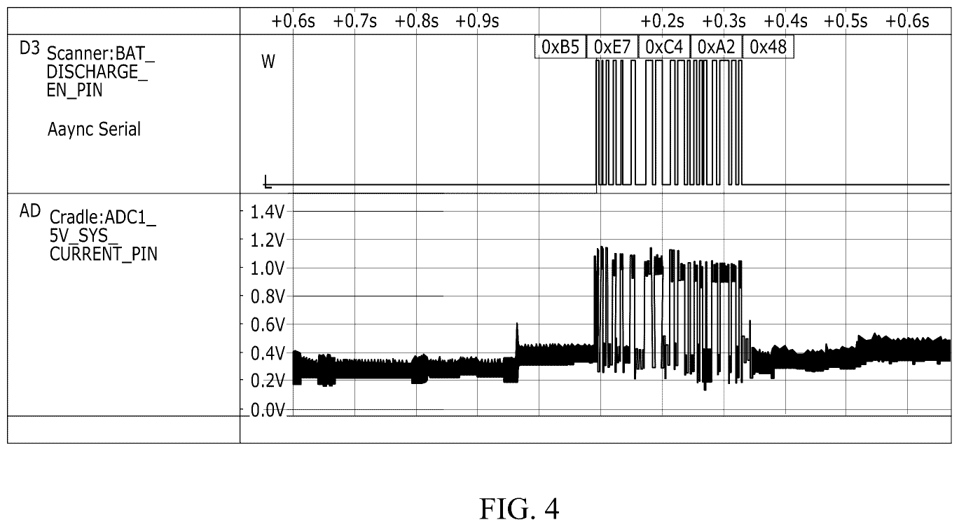

Depicted in FIG. 4 are waveforms according to an example inverted asynchronous serial communication protocol for establishing the wireless data link using the current signal. As depicted in a top portion of FIG. 4, the handheld barcode scanner 210 at rest does not draw substantial power (effectively, sending the low current signal). Accordingly, as depicted in a bottom portion of FIG. 4, the ADC 276 produces a low, substantially constant digital voltage reading. To send information to the wireless charging cradle 220 over the wireless electrical coupling 230, the handheld barcode scanner 210 enables and modulates its power draw between the low current signal and the high current signal, which the wireless charging cradle 220 detects via spikes in the digital voltage reading by the ADC 276.

In some embodiments, to reduce the effect of random spikes in the voltage measurement, the wireless charging cradle 220 uses an averaging function to determine the voltage measurement for any particular time. For example, the voltage measurement at any particular time may consist of the average voltage measurement over a measurement window of 0.5 seconds (e.g., from 0.25 seconds before the time to 0.25 seconds after the time).

As noted with respect to action 306 of FIG. 3, multiple alternative techniques are possible for identifying which measured voltage values at the wireless charging cradle 220 correspond to the high and low current signals (1 and 0, or vice versa) from the handheld barcode scanner 210. These alternative techniques will be described with respect to FIGS. 5 and 6, respectively.

Referring first to FIG. 5, a method 500 is provided according to a first technique by which the wireless charging cradle 220 may identify the high and low voltages.

At action 502, the wireless charging cradle 220 monitors a voltage measurement via the current sense amplifier 274 and ADC 276 to identify a baseline voltage (e.g., a voltage substantially maintained over a predefined duration of time, for example at least 0.25 seconds, 0.5 seconds, one second, etc.). At action 504, the wireless charging cradle 220 sets the identified baseline voltage as a low voltage corresponding to a low current signal from the handheld barcode scanner 210.

Subsequently, at action 506, the wireless charging cradle 220 continues to monitor the measured voltage to identify a subsequent measure voltage that substantially deviates from the baseline voltage (e.g., as depicted in FIG. 4, when the handheld barcode scanner 210 begins to transmit data). At action 508, the wireless charging cradle sets this deviating voltage as a high voltage corresponding to a high current signal from the handheld barcode scanner 210. The wireless charging cradle 220 thereby establishes the high and low voltages by which the wireless charging cradle 220 can interpret subsequent current signals transmitted by the handheld barcode scanner 210 over the wireless electrical coupling 230 (e.g., to establish the wireless data link, as described with respect to actions 308 and 310 of FIG. 3).

The above description of FIG. 5 particularly involves the handheld barcode scanner 210 and wireless charging cradle using an inverted communication protocol, i.e., where the baseline voltage is the low voltage. In alternate embodiments, though, the baseline voltage may be a high voltage, with deviation from the high voltage indicating the low voltage. Thus, it is envisioned that, in these embodiments, action 504 may instead include setting the identified baseline voltage as the high voltage, and action 408 may include setting the deviating voltage as the low voltage.

Moving to FIG. 6, an alternative method 600 is provided, according to a second, alternative technique by which the wireless charging cradle 220 may identify the high and low voltages. Generally speaking, rather than defining the high and low voltage values based on a deviation from an identified baseline voltage, the method 600 differentiates the high and low voltages by an alert threshold voltage value defined a priori, and for example stored at the memory 262 of the wireless charging cradle 220.

More particularly, at action 602, the method 600 includes monitoring the measured voltage from the ADC 276 and current sense amplifier 274 to identify a first, substantially sustained voltage that is lower than the predefined alert threshold (e.g., a voltage remaining substantially stable for 0.1 seconds, 0.25 seconds, 0.5 seconds, etc.). At action 604, the wireless charging cradle 220 sets this first sustained voltage as the low voltage corresponding to the low current signal of the handheld barcode scanner 210. The wireless charging cradle 220 also monitors the measured voltage to identify a second, substantially sustained voltage above the alert threshold (action 606), and sets this second sustained voltage as the high voltage corresponding to the high current signal from the handheld barcode scanner 210 (action 608). Similarly to as with this method 500 of FIG. 5, the wireless charging cradle 220 operating according to the method 600 thereby establishes the high and low voltages by which the wireless charging cradle 220 can interpret subsequent current signals transmitted by the handheld barcode scanner 210 over the wireless electrical coupling 230.

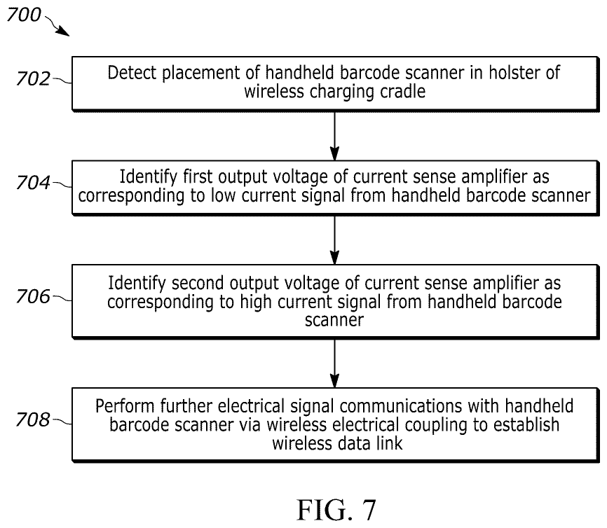

In consideration of the foregoing description, FIG. 7 depicts a block diagram of another example computer-implemented method 700, in accordance with various embodiments. The method 700 may be performed, for example, by the wireless charging cradle 220 of FIG. 2 (e.g., by executing, via the processor 264, instructions from non-transitory portions of the memory 262 and/or from one or more other non-transitory computer readable media).

The method 700 includes detecting a placement of a handheld barcode scanner in a holster of a wireless charging cradle (action 702, e.g., as described with respect to action 304 of FIG. 3).

The method 700 further includes, responsive to detecting the placement of the handheld barcode scanner, identifying a first output voltage of a current sense amplifier of the wireless charging cradle as corresponding to a low current signal received over a wireless electrical coupling from the handheld barcode scanner (action 704), and also identifying a second output voltage of the current sense amplifier as corresponding to a high current signal received over the wireless electrical coupling from the handheld barcode scanner (action 706).

In some embodiments, actions 704 and/or 706 are performed according to the techniques described with respect to FIG. 5, e.g., by (1) monitoring the output voltage of the current sense amplifier over a monitoring window to identify a baseline output voltage of the current sense amplifier, (2) identifying the baseline output voltage as being the first output voltage corresponding to a low current signal from the handheld barcode scanner, (3) further monitoring the output voltage of the current sense amplifier over the monitoring window to identify a deviation from the baseline output voltage of the current sense amplifier, the deviation producing a spike output voltage, and/or (4) identifying the spike output voltage as being the second output voltage corresponding to a high current signal from the handheld barcode scanner.

Alternatively, in embodiments, actions 704 and/or 706 are performed according to the techniques described with respect to FIG. 6, e.g., by monitoring an output voltage of the current sense amplifier over a monitoring window to (1) identify the first output voltage based on the first output voltage being below the threshold voltage, and (2) identify the second output voltage based on the second output voltage being above the threshold voltage.

The method 700 still further includes, still responsive to detecting the placement of the handheld barcode scanner, performing further electrical signal communications with the handheld barcode scanner via the wireless electrical coupling to establish a wireless data link between the wireless charging cradle and the handheld barcode scanner (action 708). Performing the further electrical signal communications may include reading further electrical current signals from the handheld barcode scanner based on the identifying of the first output voltage and second output voltage. The further electrical signal communications may, for example, serve to establish a Bluetooth link, Wi-Fi link, and/or other RF communication link between the wireless charging cradle and handheld barcode scanner, for example via any suitable technique of the present disclosure.

In some embodiments, measurements of voltage from the current sense amplifier at actions 704, 706, and/or 708 are obtained by averaging the output voltage over an averaging window. Moreover, in some embodiments, the actions 704, 706, and/or 708 may utilize an inverted asynchronous serial communication protocol.

The method 700 may include still additional, fewer, and/or alternate actions, in various embodiments. For example, portions of the method 700 may be combined or substituted with suitable actions of the methods of FIGS. 3, 5, and/or 6.

### ADDITIONAL CONSIDERATIONS

In the foregoing specification, specific embodiments/aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations/aspects should not be interpreted as mutually exclusive, and should instead be understood as potentially combinable if such combinations are permissive in any way. In other words, any feature disclosed in any of the aforementioned embodiments, examples, implementations, or aspects may be included in any of the other aforementioned embodiments, examples, implementations, or aspects.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A wireless charging cradle configured to receive a handheld barcode scanner, the wireless charging cradle comprising:
a current sense amplifier configured to (i) measure a current drawn by the handheld barcode scanner via a wireless electrical coupling of the wireless charging cradle to the handheld barcode scanner, and (ii) convert the measured current to an output voltage;
a holster configured to physically receive the handheld barcode scanner;
one or more processors; and
one or more non-transitory memories storing instructions that, when executed by the one or more processors, cause the wireless charging cradle to:
detect a placement of the handheld barcode scanner in the holster; and
responsive to detecting the placement of the handheld barcode scanner:
identify a first output voltage of the current sense amplifier as corresponding to a low current signal from the handheld barcode scanner;
identify a second output voltage of the current sense amplifier as corresponding to a high current signal from the handheld barcode scanner; and
perform further electrical signal communications with the handheld barcode scanner via the wireless electrical coupling to establish a wireless data link between the wireless charging cradle and the handheld barcode scanner, wherein performing the further electrical signal communications comprises reading further electrical current signals from the handheld barcode scanner based on the identifying of the first output voltage and second output voltage.

2. The wireless charging cradle of claim 1, wherein the instructions to identify the first output voltage comprise instructions to:
monitor the output voltage of the current sense amplifier over a monitoring window to identify a baseline output voltage of the current sense amplifier; and
identify the baseline output voltage as being the first output voltage corresponding to a low current signal from the handheld barcode scanner.

3. The wireless charging cradle of claim 2, wherein the instructions to identify the second output voltage comprise instructions to:
further monitor the output voltage of the current sense amplifier over the monitoring window to identify a deviation from the baseline output voltage of the current sense amplifier, the deviation producing a spike output voltage; and
identify the spike output voltage as being the second output voltage corresponding to a high current signal from the handheld barcode scanner.

4. The wireless charging cradle of claim 1, wherein the one or more memories store an indication of a threshold voltage,
and wherein the instructions to identify the first and second output voltages comprise instructions to monitor the output voltage of the current sense amplifier over a monitoring window to:
identify the first output voltage based on the first output voltage being below the threshold voltage; and
identify the second output voltage based on the second output voltage being above the threshold voltage.

5. The wireless charging cradle of claim 1, wherein the instructions, when executed via the one or more processors, cause the wireless charging cradle to measure the output voltage of the current sense amplifier by averaging the output voltage over an averaging window.

6. The wireless charging cradle of claim 1, wherein the further electrical signal communications utilize an inverted asynchronous serial communication protocol.

7. The wireless charging cradle of claim 1, wherein the wireless data link utilizes a Bluetooth communication protocol.

8. A computer-implemented method performed via one or more processors of a wireless charging cradle configured to receive a handheld barcode scanner, the method comprising:
detecting a placement of the handheld barcode scanner in a holster of the wireless charging cradle; and
responsive to detecting the placement of the handheld barcode scanner:
identifying a first output voltage of a current sense amplifier of the wireless charging cradle as corresponding to a low current signal received over a wireless electrical coupling from the handheld barcode scanner;
identifying a second output voltage of the current sense amplifier as corresponding to a high current signal received over the wireless electrical coupling from the handheld barcode scanner; and
performing further electrical signal communications with the handheld barcode scanner via the wireless electrical coupling to establish a wireless data link between the wireless charging cradle and the handheld barcode scanner, wherein performing the further electrical signal communications comprises reading further electrical current signals from the handheld barcode scanner based on the identifying of the first output voltage and second output voltage.

9. The computer-implemented method of claim 8, wherein identifying the first output voltage comprises:
monitoring the output voltage of the current sense amplifier over a monitoring window to identify a baseline output voltage of the current sense amplifier; and
identifying the baseline output voltage as being the first output voltage corresponding to a low current signal from the handheld barcode scanner.

10. The computer-implemented method of claim 9, wherein identifying the second output voltage comprises:
further monitoring the output voltage of the current sense amplifier over the monitoring window to identify a deviation from the baseline output voltage of the current sense amplifier, the deviation producing a spike output voltage; and
identifying the spike output voltage as being the second output voltage corresponding to a high current signal from the handheld barcode scanner.

11. The computer-implemented method of claim 8, wherein identifying the first and second output voltages comprises monitoring an output voltage of the current sense amplifier over a monitoring window to:
identify the first output voltage based on the first output voltage being below the threshold voltage; and
identify the second output voltage based on the second output voltage being above the threshold voltage.

12. The computer-implemented method of claim 8, further comprising measuring the output voltage of the current sense amplifier by averaging the output voltage over an averaging window.

13. The computer-implemented method of claim 8, wherein the further electrical signal communications utilize an inverted asynchronous serial communication protocol.

14. The computer-implemented method of claim 8, wherein the wireless data link utilizes a Bluetooth communication protocol.

15. One or more non-transitory computer readable media storing instructions that, when executed via one or more processors of a wireless charging cradle configured to receive a handheld barcode scanner, cause a wireless charging cradle to:
detect a placement of the handheld barcode scanner in a holster of the wireless charging cradle; and
responsive to detecting the placement of the handheld barcode scanner:
identify a first output voltage of a current sense amplifier of the wireless charging cradle as corresponding to a low current signal received over a wireless electrical coupling from the handheld barcode scanner;
identify a second output voltage of the current sense amplifier as corresponding to a high current signal received over the wireless electrical coupling from the handheld barcode scanner; and
perform further electrical signal communications with the handheld barcode scanner via the wireless electrical coupling to establish a wireless data link between the wireless charging cradle and the handheld barcode scanner, wherein performing the further electrical signal communications comprises reading further electrical current signals from the handheld barcode scanner based on the identifying of the first output voltage and second output voltage.

16. The one or more non-transitory computer readable media of claim 15, wherein the instructions to identify the first output voltage comprise instructions to:
monitor the output voltage of the current sense amplifier over a monitoring window to identify a baseline output voltage of the current sense amplifier; and
identify the baseline output voltage as being the first output voltage corresponding to a low current signal from the handheld barcode scanner.

17. The one or more non-transitory computer readable media of claim 16, wherein the instructions to identify the second output voltage comprise instructions to:
further monitor the output voltage of the current sense amplifier over the monitoring window to identify a deviation from the baseline output voltage of the current sense amplifier, the deviation producing a spike output voltage; and
identify the spike output voltage as being the second output voltage corresponding to a high current signal from the handheld barcode scanner.

18. The one or more non-transitory computer readable media of claim 15, wherein the instructions to identify the first and second output voltages comprise instructions to monitor output voltage over a monitoring window to:
identify the first output voltage based on the first output voltage being below a threshold voltage; and
identify the second output voltage based on the second output voltage being above the threshold voltage.

19. The one or more non-transitory computer readable media of claim 15, wherein the instructions, when executed via the one or more processors, cause the wireless charging cradle to measure the output voltage of the current sense amplifier by averaging the output voltage over an averaging window.

20. The one or more non-transitory computer readable media of claim 15, wherein the further electrical signal communications utilize an inverted asynchronous serial communication protocol.

21. The one or more non-transitory computer readable media of claim 15, wherein the wireless data link utilizes a Bluetooth communication protocol.
